(19) United States
(12) Patent Application Publication
(10) Pub. No.: US 2025/0217652 A1
(43) Pub. Date: Jul. 3, 2025

(54) DEVICE AND METHOD WITH NEURAL NETWORK DEPTH COMPRESSION

(71) Applicants: Samsung Electronics Co., Ltd., Suwon-si (KR); Seoul National University R&DB Foundation, Seoul (KR)

(72) Inventors: Jin Uk KIM, Seoul (KR); Hyun Oh SONG, Seoul (KR)

(73) Assignees: Samsung Electronics Co., Ltd., Suwon-si (KR); Seoul National University R&DB Foundation, Seoul (KR)

(21) Appl. No.: 19/007,890

(22) Filed: Jan. 2, 2025

(30) Foreign Application Priority Data
Jan. 2, 2024 (KR) 10-2024-0000209

(51) Int. Cl. G06N 3/082; G06N 3/0985

(52) U.S. Cl. CPC G06N 3/082; G06N 3/0985

(57) ABSTRACT

An electronic device includes one or more processors configured to measure importance and inference time for a plurality of blocks in which consecutive linear layers are merged, detect a location of a nonlinear layer maximizing the importance when the inference time is limited, using a dynamic programming algorithm, remove the remaining nonlinear layers except for the nonlinear layer at the detected location, and merge adjacent linear layers by removing the remaining nonlinear layers.

### CROSS-REFERENCE TO RELATED APPLICATIONS

This application claims the benefit under 35 USC § 119(a) of Korean Patent Application No. 10-2024-0000209, filed in the Korean Intellectual Property Office on Jan. 2, 2024, the entire disclosure of which is incorporated herein by reference for all purposes.

### BACKGROUND

### 1. Field

The following description relates to a device and method with neural network depth compression.

### 2. Description of the Related Art

Artificial neural network technology shows excellent performance in image classification tasks and regression tasks and is widely used in actual industries. However, as the difficulty of the task to be solved by the neural network increases and the number of data increases, the depth of the neural network deepens and its complexity increases, requiring a large amount of computing resources and capital to perform neural network inference.

For example, the artificial neural network that models the lithography process for semiconductor layers performs an inference process on more than billions of images per day in the field.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes one or more processors configured to measure importance and inference time for a plurality of blocks in which consecutive linear layers are merged, detect a location of a nonlinear layer maximizing the importance when the inference time is limited, using a dynamic programming algorithm, remove the remaining nonlinear layers except for the nonlinear layer at the detected location, and merge adjacent linear layers by removing the remaining nonlinear layers.

For the measuring of the importance and the inference time, the one or more processors may be configured to determine the importance of each of the plurality of blocks based on a change in performance of the neural network when removing at least one nonlinear layer included in each of the plurality of blocks.

For the determining of the importance of each of the plurality of blocks, the one or more processors may be configured to define an importance value of the block merged from a consecutive i-th linear layer to j-th linear layer as a performance change value of the neural network when deleted from an i+1-th nonlinear layer to j−1-th nonlinear layer.

For the measuring of the importance and the inference time, the one or more processors may be configured to measure a time taken to merge the plurality of linear layers included in each of the plurality of blocks into one, and determine the measured time as the inference time for each of the plurality of blocks.

The one or more processors may be configured to define the plurality of blocks with consecutive linear layers that is merged in an initial network, and measure the importance and the inference time for each different combination of the plurality of blocks.

For the detecting of the location of the nonlinear layer, the one or more processors may be configured to select an optimal intermediate network with maximum importance while satisfying the limitation on the inference time among the plurality of intermediate networks, and detect a location of the nonlinear layer from the selected optimal intermediate network.

For the detecting of the location of the nonlinear layer, the one or more processors may be configured to determines the maximum importance for some blocks including some consecutive layers among the plurality of consecutive linear layers through the dynamic programming algorithm, and detect the location of the nonlinear layer that maximizes the importance of the plurality of blocks based on the determined maximum importance of some of the blocks.

For the merging of the adjacent linear layers, the one or more processors may be configured to generate a final depth compression network from the optimal intermediate network based on the detected position of the nonlinear layer.

The one or more processors may be configured to perform fine-tuning training on the intermediate network from which the remaining nonlinear layers are removed.

When distributing the fine-tuned final neural network, the one or more processors may be configured to distribute an accelerated neural network by merging adjacent linear layers into one.

In one or more general aspects, a processor-implemented method includes measuring importance and inference time for a plurality of blocks including consecutive linear layers, detecting a location of a nonlinear layer maximizing the importance when the inference time is limited, using a dynamic programming algorithm, removing the remaining nonlinear layers except for the nonlinear layer at the detected location, and merging adjacent linear layers by removing the remaining nonlinear layers.

The measuring of the importance and the inference time may include determining the importance of each of the plurality of blocks based on a change in performance of the neural network when removing at least one nonlinear layer included in each of the plurality of blocks.

The determining of the importance of each of the plurality of blocks may include defining an importance value of the block merged from a consecutive i-th linear layer to j-th linear layer as a performance change value of the neural network when deleted from an i+1-th nonlinear layer to j−1-th nonlinear layer.

The measuring of the importance and the inference time may include measuring a time taken to merge the plurality of linear layers included in each of the plurality of blocks into one, and determining the measured time as the inference time for each of the plurality of blocks.

The method may include defining the plurality of blocks with consecutive linear layers that are merged in an initial network, and generating a plurality of intermediate networks each composed of a different combination of the plurality of blocks.

The detecting of the location of the nonlinear layer may include selecting an optimal intermediate network with maximum importance while satisfying the limitation on the inference time among the plurality of intermediate networks, and detecting a location of the nonlinear layer from the selected optimal intermediate network.

The detecting of the location of the nonlinear layer further may include determining the maximum importance for some blocks including some consecutive layers among the plurality of consecutive linear layers through the dynamic programming algorithm, and detecting the location of the nonlinear layer that maximizes the importance of the plurality of blocks based on the determined maximum importance of some of the blocks.

The merging of the adjacent linear layers further may include generating a final depth compression network from the optimal intermediate network based on the detected position of the nonlinear layer.

The method may include performing fine-tuning training on the intermediate network from which the remaining nonlinear layers are removed.

The method may include distributing an accelerated neural network by merging adjacent linear layers into one when distributing the fine-tuned final neural network.

Other features and aspects will be apparent from the following detailed description, the drawings, and the claims.

### BRIEF DESCRIPTION OF THE DRAWINGS

FIG. 1 is a diagram illustrating a dynamic programming based neural network depth compression method according to one or more embodiments of the present disclosure.

FIG. 2 is a block diagram of a dynamic programming based neural network depth compression device according to one or more embodiments of the present disclosure.

FIG. 3 is a flowchart of a dynamic programming based neural network depth compression method according to one or more embodiments of the present disclosure.

FIG. 4 is a block diagram for describing a dynamic programming based neural network depth compression method according to one or more embodiments of the present disclosure.

FIG. 5 is tables showing an effect of a dynamic programming based neural network depth compression method according to one or more embodiments of the present disclosure.

FIG. 6 is a diagram for describing a computing device according to one or more embodiments of the present disclosure.

Throughout the drawings and the detailed description, unless otherwise described or provided, it may be understood that the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms including technical and scientific terms used herein have the same meaning as commonly understood by one of ordinary skill in the art to which the present disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Terms such as “ . . . unit,” “ . . . er/or,” and “module” used in the specification mean a hardware component configured to process at least one function or operation described in the specification, which may be implemented as hardware or a circuit (e.g., hardware implementing software).

Hereinafter, embodiments of the present disclosure will be described with reference to the drawings.

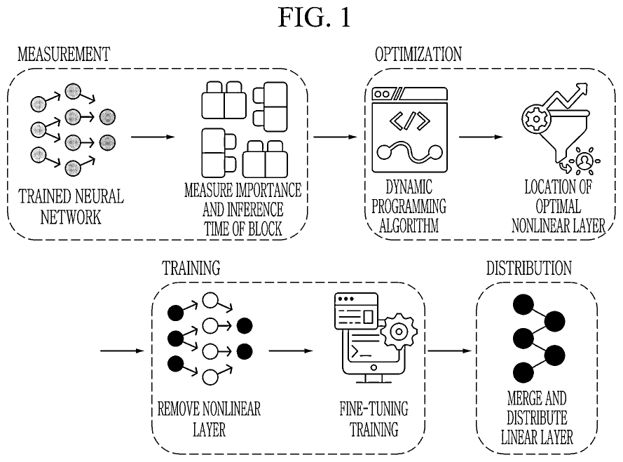

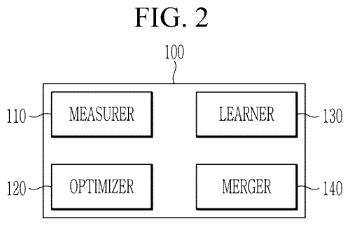

FIG. 1 is a diagram illustrating a dynamic programming based neural network depth compression method according to one or more embodiments of the present disclosure. FIG. 2 is a block diagram of a dynamic programming based neural network depth compression device according to one or more embodiments of the present disclosure.

A device and method of one or more embodiments may accelerate inference speed while maintaining the performance of an artificial neural network, thereby greatly saving resources and capital. The dynamic programming based neural network depth compression method of one or more embodiments may accelerate inference speed while maintaining performance of the artificial neural network, and may accelerate the inference speed by compressing the depth of the neural network with a large number of layers.

For example, the dynamic programming based neural network depth compression method may remove nonlinear layers and merge adjacent linear layers. For this purpose, the dynamic programming based neural network depth compression method may include a method of detecting a location of a nonlinear layer to be left without removal using a dynamic programming algorithm.

In FIG. 1, the dynamic programming based neural network depth compression method may measure importance (e.g., an importance value) and an inference time for all blocks that can be merged from the neural network trained in the measuring step.

In response to the measuring of the importance and the inference time, the dynamic programming based neural network depth compression method may use the dynamic programming algorithm in the optimization step to detect the location of the nonlinear layer that maximizes the importance value when the inference time is limited.

In addition, the dynamic programming based neural network depth compression method may remove the remaining nonlinear layers except for the layer at the location of the nonlinear layer detected in the training step and may put the neural network through a fine-tuning training process.

In response to removing the remaining nonlinear layers except for the layer at the detected location, the dynamic programming based neural network depth compression method may remove the nonlinear layer in the distribution step and distribute the accelerated neural network by merging adjacent linear layers into one when distributing the neural network that has gone through the fine-tuning training process.

The dynamic programming based neural network depth compression method may be performed by the dynamic programming based neural network depth compression device 100.

Referring to FIG. 2, the dynamic programming based neural network depth compression device 100 may include a measurer 110, an optimizer 120, a learner 130, and a merger 140.

The measurer 110 may measure the importance and the inference time for a plurality of blocks in which consecutive linear layers are merged.

The measurer 110 may view the consecutive linear layers that may be merged into one layer as one block and measure the importance and the inference time of each block.

The measurer 110 may determine the importance of each of the plurality of blocks based on a change in performance of the neural network when removing at least one nonlinear layer included in each of the plurality of blocks.

In this case, the definition of the importance value of the block merged from an i-th linear layer to j-th linear layer may be determined by Equation 1 below, for example.

$$I [ i , j ] := {max}_{θ} Acc ( {\underbrace{{{○}^{L}}_{l = j + 1} {σ}_{l} ∘ {f}_{{θ}_{l}}}}_{j + 1 to L layers} ∘ {\underbrace{{σ}_{j} ∘ {{○}^{j}}_{l = i + 1} {f}_{{θ}_{l}}}}_{i + 1 to j layers} ∘ {\underbrace{{{○}^{i}}_{l = 1} {σ}_{l} ∘ {f}_{{θ}_{l}}}}_{1 to i layers} ) - {max}_{θ} Acc ( {{○}^{L}}_{l = 1} {σ}_{l} ∘ {f}_{{θ}_{l}} ) . \qquad Equation 1$$

Here, σᵢ refers to the i-th nonlinear layer, and f_{θ}_{ᵢ} refers to the i-th linear layer. ○(small circle) is a composite function operation, which refers to sequentially passing through the layers. ◯(big circle) refers to applying the composite function operation several times in succession.

An importance value I[i, j] may be defined as a performance change value of the neural network when deleted and merged from an i+1-th nonlinear layer to a j−1-th nonlinear layer.

That is, the measurer 110 may define the importance value of the block merged from the consecutive i-th linear layer to j-th linear layer as the performance change value of the neural network when deleted from the i+1-th nonlinear layer to j−1-th nonlinear layer.

The measurer 110 may assign low importance to the block when the performance drops more than a certain standard (e.g., when the performance is less than a threshold value) when the nonlinear layers within the corresponding block are removed, and high importance to the block when the performance drops less than a certain standard.

The measurer 110 may measure a time taken for merging the plurality of linear layers included in each of the plurality of blocks into one and determine the measured time as the inference time for each of the plurality of blocks.

For example, the measurer 110 may measure the time it takes to merge each block into one linear layer, and expresses a latency value of blocks merged from the i-th linear layer to the j-th linear layer to T[i, j].

That is, the measurer 110 may define the plurality of blocks with consecutive linear layers that is merged in the initial network, and measure the importance and the inference time for each different combination of the plurality of blocks.

In response to the measurer 110 measuring both the importance I[i, j] and the inference time T[i, j] of the blocks that can be merged, the optimizer 120 may design a discrete optimization problem to find the location of the nonlinear layer to maximize the sum of importance when the sum of inference time for blocks is limited. The corresponding discrete optimization problem may be Equation 2 below, for example.

$${maximize}_{A ⊆ [ L - 1 ]} {\sum }_{{a}_{j - 1} , {a}_{j} ∈ \{ 0 \} ⋃ A ⋃ \{ L \}} I [ {a}_{j - 1} , {a}_{j} ] \qquad Equation 2$$

$$subject to {\sum }_{{a}_{i - 1} , {a}_{i} ∈ \{ 0 \} ⋃ A ⋃ \{ L \}} T [ {a}_{i - 1} , {a}_{i} ] < {T}_{0} .$$

Here, A refers to a set of positions of nonlinear layers that will be left without being removed, and aⱼ refers to a small element as j-th in A. [L−1] refers to {1, 2, . . . , L−1}, and I[i, j] and T[i, j] refer to the importance value and inference time value of the block merged from the i to the j-th block defined previously. T₀ refers to an inference timeout time.

The optimizer 120 may use a dynamic programming algorithm to optimize the location of the nonlinear layer that maximizes importance when inference time is limited.

The optimizer 120 may determine the maximum importance for some blocks including some consecutive layers among the plurality of consecutive linear layers through the dynamic programming algorithm.

The optimizer 120 may find an optimal solution in the discrete optimization problem through the dynamic programming algorithm. A core inductive relationship of the dynamic programming algorithm used may be defined as Equation 3 below, for example.

$$D [ l , t ] ← {max}_{0 \leq {l}_{0} \leq l} ( {\underbrace{D [ {l}_{0} , t - T [ {l}_{0} , l ] ]}}_{Optimal importance up to {l}_{0} - layer} + {\underbrace{I [ {l}_{0} , l ]}}_{Importance of the last block} ) \qquad Equation 3$$

Here, D[I, t] is the importance value that may be reached when optimally merged up to the Ith layer of the neural network using t inference time, and l₀ is a layer with an index smaller than I. D[l₀, t-T[, I]] is an importance value that may be reached when optimally merged using inference time as much as t-T [l₀, I] up to the l₀-th layer, and [l₀, I] is the importance value of the block merged from the l₀-th layer to the I-th layer.

In other words, the optimizer 120 may determine the optimal importance that may be reached in all layers of the neural network using the inductive relationship based on the optimally merged importance of the intermediate layers of the neural network determined through Equation 3.

The optimizer 120 may detect the location of the optimal nonlinear layer that maximizes the importance of the plurality of blocks based on the determined maximum importance.

In one or more embodiments, the optimizer 120 may define the plurality of blocks with consecutive linear layers that is merged in the initial network of the neural network, and measure the importance and the inference time for each different combination of the plurality of blocks.

The optimizer 120 may generate a plurality of intermediate networks each composed of a combination of the plurality of blocks.

The optimizer 120 may select an optimal intermediate network with maximum importance while satisfying limitations on inference time among the plurality of intermediate networks.

The optimizer 120 may detect the location of the optimal nonlinear layer from the selected optimal intermediate network.

The learner 130 may remove the remaining nonlinear layers except for the location of the detected nonlinear layer.

The learner 130 may perform the fine-tuning training on the intermediate network from which the remaining nonlinear layers are removed.

The merger 140 may merge adjacent linear layers by removing the remaining nonlinear layers.

The merger 140 may perform a linear operation in advance on the weights of consecutive linear layers and merge the weights into one weight. The weight merging process of the linear layers may be determined using Equation 4 below, for example.

$$f ( x ) = {W}_{B} ( {W}_{A} x ) = {W}_{merge} x , ( {W}_{merge} = {W}_{B} {W}_{A} ) \qquad Equation 4$$

Here, x refers to input data, and f refers to a neural network with consecutive linear layers. W_{A} and W_{B} refer to a weight of a first linear layer and a weight of a second linear layer, respectively, and W_{merge} refers to the weight of the merged linear layer.

Since each linear layer performs an operation in the form of matrix multiplication, two consecutive linear layers may be merged into one linear layer for a new matrix, as may be seen in Equation 4 above.

The merger 140 may generate a final depth compression network from the optimal intermediate network based on the detected position of the optimal nonlinear layer.

When distributing the fine-tuned final neural network, the merger 140 may distribute an accelerated neural network by merging adjacent linear layers into one.

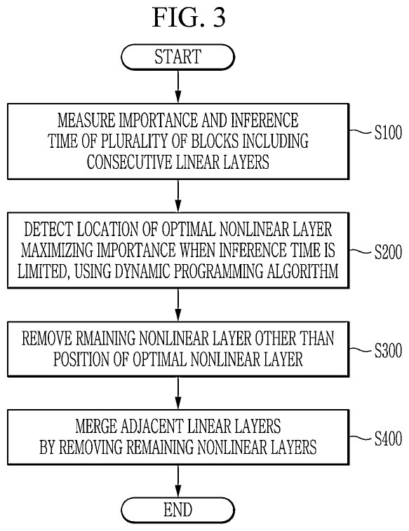

FIG. 3 is a flowchart of a dynamic programming based neural network depth compression method according to the embodiment of the present disclosure. Operations S100 to S400 to be described hereinafter may be performed sequentially in the order and manner as shown and described below with reference to FIG. 3, but the order of one or more of the operations may be changed, one or more of the operations may be omitted, and two or more of the operations may be performed in parallel or simultaneously without departing from the spirit and scope of the example embodiments described herein. The dynamic programming based neural network depth compression method in FIG. 3 may be performed by the dynamic programming based neural network depth compression device 100 (see FIG. 2).

The dynamic programming based neural network depth compression device 100 may measure the importance and the inference time for the plurality of blocks including the consecutive linear layers (step S100).

The dynamic programming based neural network depth compression device 100 may use a dynamic programming algorithm to optimize the location of the nonlinear layer that maximizes importance when inference time is limited (step S200).

The dynamic programming based neural network depth compression device 100 may remove the remaining nonlinear layers except for the location of the detected nonlinear layer (step S300).

The dynamic programming based neural network depth compression device 100 may merge adjacent linear layers by removing the remaining nonlinear layers (step S400).

That is, in response to the dynamic programming based neural network depth compression device 100 obtaining the location of the optimal nonlinear layer using the dynamic programming algorithm, the dynamic programming based neural network depth compression device 100 may remove all nonlinear layers in locations other than the location of the optimal nonlinear layer from the trained neural network and perform the fine-tuning training process for a certain period of time.

The dynamic programming based neural network depth compression device 100 of one or more embodiments may accelerate the inference time by merging the adjacent linear layers into one layer when distributing the fine-tuned network.

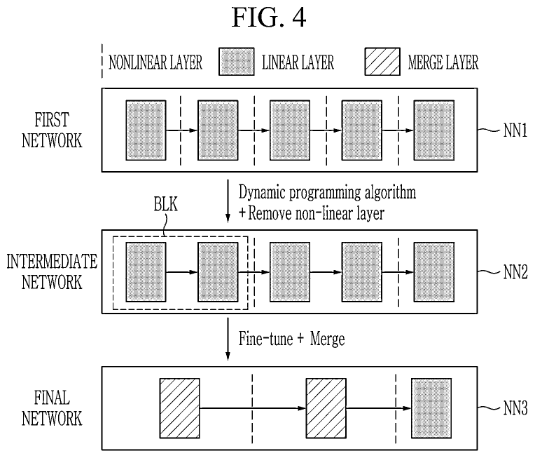

FIG. 4 is a block diagram for describing a dynamic programming based neural network depth compression method according to one or more embodiments of the present disclosure. FIG. 4 describes an example of the dynamic programming based neural network depth compression method of FIG. 3 in more detail.

In FIG. 4, the initial network includes five consecutive linear layers. An initial network NN1 includes four nonlinear layers arranged between five consecutive linear layers.

The dynamic programming based neural network depth compression device 100 may generate a plurality of blocks BLK based on the five consecutive linear layers of the initial network NN1. The block BLK is a combination of at least the two consecutive linear layers into one.

For example, the dynamic programming based neural network depth compression device 100 may generate about 16 types of intermediate networks based on the five consecutive linear layers of the initial network NN1. Each intermediate network may include different blocks BLK. Each intermediate network may include a combination of different blocks BLK.

For example, the dynamic programming based neural network depth compression device 100 determines the importance of each of the plurality of blocks based on the change in performance of the neural network when removing at least one nonlinear layer included in each of the plurality of blocks.

For example, the dynamic programming based neural network depth compression device 100 may determine the importance of blocks merged from the i-th linear layer to the j-th linear layer according to Equation 1 below, for example.

$$I [ i , j ] := {max}_{θ} Acc ( {\underbrace{{{○}^{L}}_{l = j + 1} {σ}_{l} ∘ {f}_{{θ}_{l}}}}_{j + 1 to L layers} ∘ {\underbrace{{σ}_{j} ∘ {{○}^{j}}_{l = i + 1} {f}_{{θ}_{l}}}}_{i + 1 to j layers} ∘ {\underbrace{{{○}^{i}}_{l = 1} {σ}_{l} ∘ {f}_{{θ}_{l}}}}_{1 to i layers} ) - {max}_{θ} Acc ( {{○}^{L}}_{l = 1} {σ}_{l} ∘ {f}_{{θ}_{l}} ) . \qquad Equation 1$$

Here, σᵢ refers to the i-th nonlinear layer, and f_{θ}_{ᵢ} refers to the i-th linear layer. ○(small circle) is a composite function operation, which refers to sequentially passing through the layers. ◯(big circle) refers to applying the composite function operation several times in succession.

An importance value I[i, j] may be defined as a performance change value of the neural network when deleted and merged from an i+1th nonlinear layer to a j−1th nonlinear layer.

The dynamic programming based neural network depth compression device 100 may measure a time taken to merge the plurality of linear layers included in each of the plurality of blocks into one and determine the measured time as the inference time for each of the plurality of blocks.

The dynamic programming based neural network depth compression device 100 may select an optimal intermediate network NN2 with optimal importance among the plurality of intermediate networks. The optimal intermediate network NN2 may include blocks that satisfy the limitation on the inference time and have the maximum importance value.

The dynamic programming based neural network depth compression device 100 uses the dynamic programming algorithm to detect the locations of the optimal nonlinear layers that satisfy the limited inference time and include a combination of blocks with maximum importance.

The dynamic programming based neural network depth compression device 100 may detect the location of the nonlinear layer that maximizes the sum of importance when the sum of the inference time of the block is limited through Equation 2 below, for example.

$${maximize}_{A ⊆ [ L - 1 ]} {\sum }_{{a}_{j - 1} , {a}_{j} ∈ \{ 0 \} ⋃ A ⋃ \{ L \}} I [ {a}_{j - 1} , {a}_{j} ] \qquad Equation 2$$

$$subject to {\sum }_{{a}_{i - 1} , {a}_{i} ∈ \{ 0 \} ⋃ A ⋃ \{ L \}} T [ {a}_{i - 1} , {a}_{i} ] < {T}_{0} .$$

Here, A refers to a set of positions of nonlinear layers that will be left without being removed, and aⱼ refers to a small element as j-th in A. [L−1] refers to {1, 2, . . . , L−1}, and I[i, j] and T[i, j] refer to the importance value and inference time value of the block merged from the i to the j-th block defined previously. T₀ refers to an inference timeout time. T₀

The dynamic programming based neural network depth compression device 100 may find the location of the optimal nonlinear layer that maximizes the sum of the importance of blocks from Equation 2 through the dynamic programming algorithm of Equation 3 below, for example.

$$D [ l , t ] ← {max}_{0 \leq {l}_{0} \leq l} ( {\underbrace{D [ {l}_{0} , t - T [ {l}_{0} , l ] ]}}_{Optimal importance up to {l}_{0} - layer} + {\underbrace{I [ {l}_{0} , l ]}}_{Importance of the last block} ) \qquad Equation 3$$

Here, D[I, t] is the importance value that may be reached when optimally merged up to the I-th layer of the neural network using t inference time, and l₀ is a layer with an index smaller than I. D[l₀, t-T[, I]] is an importance value that may be reached when optimally merged using inference time as much as t-T[l₀, l] up to the l₀-th layer, and I[l₀, l] is the importance value of the block merged from the l₀-th layer to the I-th layer.

That is, the dynamic programming based neural network depth compression device 100 may determine the maximum importance for some blocks including some consecutive layers among the plurality of consecutive linear layers using the dynamic programming algorithm, and inductively detect the location of the optimal nonlinear layer that maximizes the importance of the plurality of blocks, based on the determined maximum importance of some blocks.

The dynamic programming based neural network depth compression device 100 may generate an optimal intermediate network NN2 by removing all nonlinear layers located at locations other than the optimal nonlinear layer locations.

For example, in FIG. 4, the optimal locations of the nonlinear layers are the locations of the second and fourth nonlinear layers. That is, the dynamic programming based neural network depth compression device 100 may remove the first and third nonlinear layers except for the second and fourth nonlinear layers.

The dynamic programming based neural network depth compression device 100 may go through the fine-tuning training in the optimal intermediate network NN2 and then perform the merging between the adjacent linear layers to generate the final depth compression network NN3 including at least one merge layer.

For example, the dynamic programming based neural network depth compression device 100 may merge the first and second linear layers into one and the third and fourth linear layers into one.

The final depth compression network NN3 may be an accelerated efficient neural network compared to the first network NN2.

The dynamic programming based neural network depth compression device 100 may merge the adjacent linear layers into one when distributing the fine-tuned final neural network.

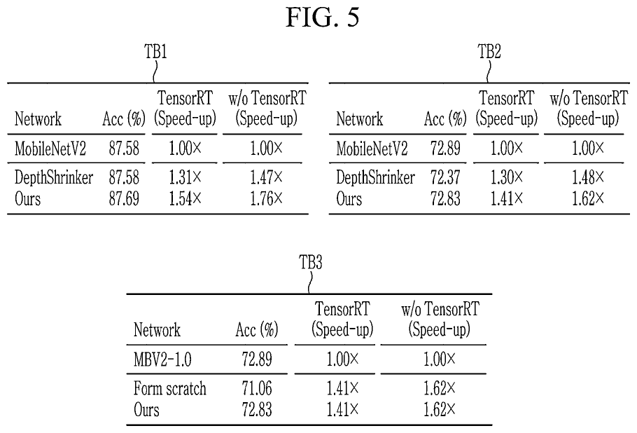

FIG. 5 is tables showing an effect of a dynamic programming based neural network depth compression method according to one or more embodiments of the present disclosure.

A first table TB1 and a second table TB2 show the results of applying the related art (MobileNetV2) to the image classification task and the results of applying and example of present disclosure (ours) to the image classification task.

It may be seen from the first table TB1 and the second table TB2 that the present disclosure (ours) achieves higher accuracy and faster inference speed.

That is, according to the first table TB1 and the second table TB2, it may be seen that the neural network generated according to the dynamic programming based neural network depth compression device 100 of one or more embodiments of the present disclosure achieves higher classification accuracy and faster inference speed to implement an efficient neural network structure compared to a neural network generated according to a typical compression device (MobileNetV2).

A third table TB3 shows performance comparison with Comparative Example (MBV2-1.0) when the structure of the efficient neural network generated according to the present disclosure (ours) was trained from-the-scratch rather than using the pre-trained weights.

In the third table TB3, when the neural network structure found in the process of the present disclosure is fixed and trained starting from random weights, compared to when the pre-trained weights are used, it may be confirmed that it has lower classification accuracy.

That is, as suggested in the present disclosure, the device and method of one or more embodiments may generate a neural network with higher performance by starting from the pre-trained weights, finding an efficient neural network, and going through a fine-tuning learning process.

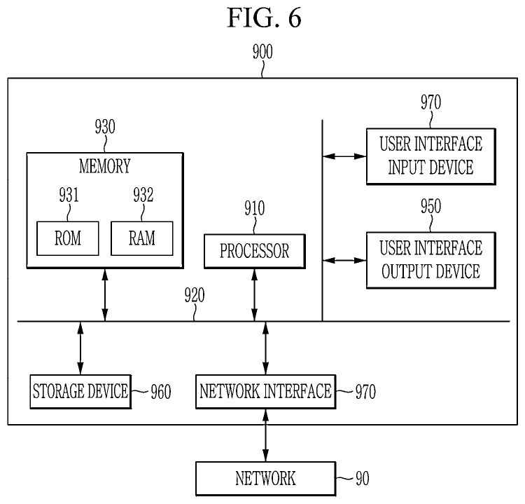

FIG. 6 is a diagram for describing a computing device according to one or more embodiments of the present disclosure.

Referring to FIG. 6, the dynamic programming based neural network depth compression device and method according to embodiments may be implemented using a computing device 900.

The computing device 900 may include a processor 910 (e.g., one or more processors), a memory 930 (e.g., one or more memories), a user interface input device 940, a user interface output device 950, and a storage device 960 that communicate via a bus 920. The computing device 900 may also include a network interface 970 that is electrically connected to network 90. The network interface 970 may transmit or receive signals to and from other entities through the network 90.

The processor 910 may be implemented in various types such as a micro controller unit (MCU), an application processor (AP), a central processing unit (CPU), a graphic processing unit (GPU), a neural processing unit (NPU), and may be any semiconductor device that executes instructions stored in the memory 930 or the storage device 960. The processor 910 may be configured to implement the functions and methods described above with reference to FIGS. 1 to 5. For example, the memory 930 may include a non-transitory computer-readable storage medium storing instructions that, when executed by the processor 910, configure the processor 910 to perform any one, any combination, or all of the operations and/or methods described above with reference to FIGS. 1 to 5. In an example, the processor 910 may include any one or any combination of any two or more of the compression device 100, the measurer 110, the optimizer 120, the learner 130, and the merger 140 of FIG. 2.

The memory 930 and the storage device 960 may include various types of volatile or non-volatile storage media. For example, the memory may include a read only memory (ROM) 931 and a random access memory (RAM) 932. In one or more embodiments of the present disclosure, the memory 930 may be positioned inside or outside the processor 910, and the memory 930 may be connected to the processor 910 through various means that are well-known.

The dynamic programming based neural network depth compression devices, measurers, optimizers, learners, mergers, computing devices, processors, buses, memories, ROMs, RAMs, user interface input devices, user interface output devices, storage devices, network interfaces, networks, dynamic programming based neural network depth compression device 100, measurer 110, optimizer 120, learner 130, merger 140, computing device 900, processor 910, bus 920, memory 930, ROM 931, RAM 932, user interface input device 940, user interface output device 950, storage device 960, network interface 970, and network 90 described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-6 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors configured to:
measure importance and inference time for a plurality of blocks in which consecutive linear layers are merged;
detect a location of a nonlinear layer maximizing the importance when the inference time is limited, using a dynamic programming algorithm;
remove the remaining nonlinear layers except for the nonlinear layer at the detected location; and
merge adjacent linear layers by removing the remaining nonlinear layers.

2. The device of claim 1, wherein, for the measuring of the importance and the inference time, the one or more processors are configured to determine the importance of each of the plurality of blocks based on a change in performance of the neural network when removing at least one nonlinear layer included in each of the plurality of blocks.

3. The device of claim 2, wherein, for the determining of the importance of each of the plurality of blocks, the one or more processors are configured to define an importance value of the block merged from a consecutive i-th linear layer to j-th linear layer as a performance change value of the neural network when deleted from an i+1-th nonlinear layer to j−1-th nonlinear layer.

4. The device of claim 1, wherein, for the measuring of the importance and the inference time, the one or more processors are configured to:
measure a time taken to merge the plurality of linear layers included in each of the plurality of blocks into one; and
determine the measured time as the inference time for each of the plurality of blocks.

5. The device of claim 1, wherein the one or more processors are configured to:
define the plurality of blocks with consecutive linear layers that is merged in an initial network; and
measure the importance and the inference time for each different combination of the plurality of blocks.

6. The device of claim 5, wherein, for the detecting of the location of the nonlinear layer, the one or more processors are configured to:
select an optimal intermediate network with maximum importance while satisfying the limitation on the inference time among the plurality of intermediate networks; and
detect a location of the nonlinear layer from the selected optimal intermediate network.

7. The device of claim 6, wherein, for the detecting of the location of the nonlinear layer, the one or more processors are configured to:
determines the maximum importance for some blocks including some consecutive layers among the plurality of consecutive linear layers through the dynamic programming algorithm; and
detect the location of the nonlinear layer that maximizes the importance of the plurality of blocks based on the determined maximum importance of some of the blocks.

8. The device of claim 7, wherein, for the merging of the adjacent linear layers, the one or more processors are configured to generate a final depth compression network from the optimal intermediate network based on the detected position of the nonlinear layer.

9. The device of claim 1, wherein the one or more processors are configured to perform fine-tuning training on the intermediate network from which the remaining nonlinear layers are removed.

10. The device of claim 9, wherein, when distributing the fine-tuned final neural network, the one or more processors are configured to distribute an accelerated neural network by merging adjacent linear layers into one.

11. A processor-implemented method comprising:
measuring importance and inference time for a plurality of blocks including consecutive linear layers;
detecting a location of a nonlinear layer maximizing the importance when the inference time is limited, using a dynamic programming algorithm;
removing the remaining nonlinear layers except for the nonlinear layer at the detected location; and
merging adjacent linear layers by removing the remaining nonlinear layers.

12. The method of claim 11, wherein the measuring of the importance and the inference time comprises determining the importance of each of the plurality of blocks based on a change in performance of the neural network when removing at least one nonlinear layer included in each of the plurality of blocks.

13. The method of claim 12, wherein the determining of the importance of each of the plurality of blocks comprises defining an importance value of the block merged from a consecutive i-th linear layer to j-th linear layer as a performance change value of the neural network when deleted from an i+1-th nonlinear layer to j−1-th nonlinear layer.

14. The method of claim 11, wherein the measuring of the importance and the inference time comprises:
measuring a time taken to merge the plurality of linear layers included in each of the plurality of blocks into one; and
determining the measured time as the inference time for each of the plurality of blocks.

15. The method of claim 11, further comprising:
defining the plurality of blocks with consecutive linear layers that are merged in an initial network; and
generating a plurality of intermediate networks each composed of a different combination of the plurality of blocks.

16. The method of claim 15, wherein the detecting of the location of the nonlinear layer comprises:
selecting an optimal intermediate network with maximum importance while satisfying the limitation on the inference time among the plurality of intermediate networks; and
detecting a location of the nonlinear layer from the selected optimal intermediate network.

17. The method of claim 16, wherein the detecting of the location of the nonlinear layer further comprises:
determining the maximum importance for some blocks including some consecutive layers among the plurality of consecutive linear layers through the dynamic programming algorithm, and detecting the location of the nonlinear layer that maximizes the importance of the plurality of blocks based on the determined maximum importance of some of the blocks.

18. The method of claim 17, wherein the merging of the adjacent linear layers further comprises generating a final depth compression network from the optimal intermediate network based on the detected position of the nonlinear layer.

19. The method of claim 11, further comprising performing fine-tuning training on the intermediate network from which the remaining nonlinear layers are removed.

20. The method of claim 19, further comprising distributing an accelerated neural network by merging adjacent linear layers into one when distributing the fine-tuned final neural network.
